(19) United States
(12) Patent Application Publication
(10) Pub. No.: US 2026/0018337 A1
(43) Pub. Date: Jan. 15, 2026

(54) MULTILAYER CERAMIC ELECTRONIC COMPONENT

(71) Applicant: Murata Manufacturing Co., Ltd., Nagaokakyo-shi (JP)

(72) Inventors: Tomoki KITAGAWA, Nagaokakyo-shi (JP); Tatsunori YASUDA, Nagaokakyo-shi (JP)

(21) Appl. No.: 19/338,095

(22) Filed: Sep. 24, 2025

Related U.S. Application Data
(63) Continuation of application No. PCT/JP2024/000953, filed on Jan. 16, 2024.

(30) Foreign Application Priority Data
Mar. 30, 2023 (JP) 2023-055774

(51) Int. Cl. H01G 2/10; H01G 2/06; H01G 4/232; H01G 4/248; H01G 4/30

(52) U.S. Cl. CPC H01G 2/10; H01G 2/065; H01G 4/232; H01G 4/248; H01G 4/30

(57) ABSTRACT

A multilayer ceramic electronic component includes a multilayer body and external electrodes on end surfaces of the multilayer body, connected to an internal electrode layer, and extending to main surfaces of the multilayer body, and spacers on both end surface sides of one main surface side of the multilayer body, and sandwiching the external electrodes. The spacers are longer than the external electrodes, in a length direction, and each include an intermetallic compound including at least one of Cu, Ni, or Sn, and a protective material. If each of the spacers is divided into two portions in the length direction along a line extending in a stacking direction, a content ratio of the protective material is higher in a region closer to a central portion of the multilayer body in the length direction than in a region farther from the central portion.

### CROSS REFERENCE TO RELATED APPLICATIONS

This application claims the benefit of priority to Japanese Patent Application No. 2023-055774 filed on Mar. 30, 2023 and is a Continuation application of PCT Application No. PCT/JP2024/000953 filed on Jan. 16, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic electronic components such as multilayer ceramic capacitors are widely used in various electronic devices such as mobile terminal devices including mobile phones and personal computers. Such multilayer ceramic capacitors each include a rectangular parallelepiped-shaped multilayer body in which dielectric layers and internal electrode layers are alternately laminated, and external electrodes provided at both opposed ends of the multilayer body.

The multilayer ceramic capacitors each include an inner layer portion in which the dielectric layers and the internal electrodes are alternately laminated. Then, dielectric layers defining and functioning as outer layer portions are provided at the top and bottom of the inner layer portion to form a rectangular parallelepiped-shaped multilayer body, and external electrodes are provided on both end surfaces in the longitudinal direction of the multilayer body to form a capacitor main body.

Furthermore, in order to suppress the occurrence of “acoustic noise”, multilayer ceramic capacitors have been known that each including a spacer that covers a portion of the external electrode on a side of the capacitor main body to be mounted on a substrate (see, for example, Japanese Unexamined Patent Application, Publication No. 2015-216337).

However, when the bonding strength between the capacitor main body and the spacer is weak, the spacer may peel off, which is not sufficient in terms of durability when mounted.

### SUMMARY OF THE INVENTION

Example embodiments of the present invention provide multilayer ceramic capacitors, each with high bonding strength between a capacitor main body and a spacer, and each with excellent durability when mounted.

A multilayer ceramic electronic component according to an example embodiment of the present invention includes a capacitor main body including a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction, two external electrodes each on a corresponding one of the two end surfaces, and each extending to the two main surfaces and the two lateral surfaces to cover a portion of each of the two main surfaces and a portion of each of the two lateral surfaces, and two spacers on one of the two main surfaces of the capacitor main body, the two spacers being respectively adjacent to one of the two end surfaces and adjacent to an other of the two end surfaces with a corresponding one of the two external electrodes respectively covering the portion of each of the two main surfaces interposed between the capacitor main body and a corresponding one of the two spacers, in which each of the two spacers is longer in the length direction than a corresponding one of the external electrodes covering the portion of each of the two main surfaces, and includes a metal component and a protective material, and when each of the two spacers is divided into two regions in the length direction along a line extending in the lamination direction, a region closer to a middle portion in the length direction of the capacitor main body has a higher content ratio of the protective material than a region farther from the middle portion.

According to example embodiments of the present invention, multilayer ceramic capacitors, each with high bonding strength between a capacitor main body and a spacer, and each with excellent durability when mounted are provided.

The above and other elements, features, steps, characteristics and advantages of the present invention will become more apparent from t following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along the line II-II in FIG. 1 of the multilayer ceramic capacitor 1.

FIG. 3 is a cross-sectional view taken along the line III-III in FIG. 1 of the multilayer ceramic capacitor 1.

FIG. 4 is an enlarged view of a portion of a spacer 4 in the cross-sectional view of the multilayer ceramic capacitor 1 shown in FIG. 2.

FIG. 5 is a flowchart explaining a manufacturing method of the multilayer ceramic capacitor 1.

FIGS. 6A to 6D are diagrams explaining a multilayer body manufacturing step S1 and an external electrode formation step S2 according to an example embodiment of the present invention.

FIGS. 7A to 7C are diagrams explaining a protective material and reinforcement portion paste placement step S3, a spacer paste placement step S4, and a reflow step S5 according to an example embodiment of the present invention.

FIG. 8 is a flowchart showing a protective material 6 and reinforcement portion formation step in a modified example according to an example embodiment of the present invention.

FIGS. 9A to 9D are diagrams explaining a protective material 6 and reinforcement portion formation step in a modified example according to an example embodiment of the present invention.

### DETAILED DESCRIPTION OF THE EXAMPLE EMBODIMENTS

Example embodiments of the present invention will be described in detail below with reference to the drawings.

In the following, a multilayer ceramic capacitor 1 will be described as an example embodiment of the multilayer ceramic electronic component of the present invention, but the present invention is not limited thereto. Also, the drawings may be schematically simplified to explain the contents of example embodiments of the present invention, and the ratio of dimensions of the components or between components depicted may not match the ratio of their dimensions described in the specification. Also, components described in the specification may be omitted in the drawings, or the number of components may be reduced in the drawings.

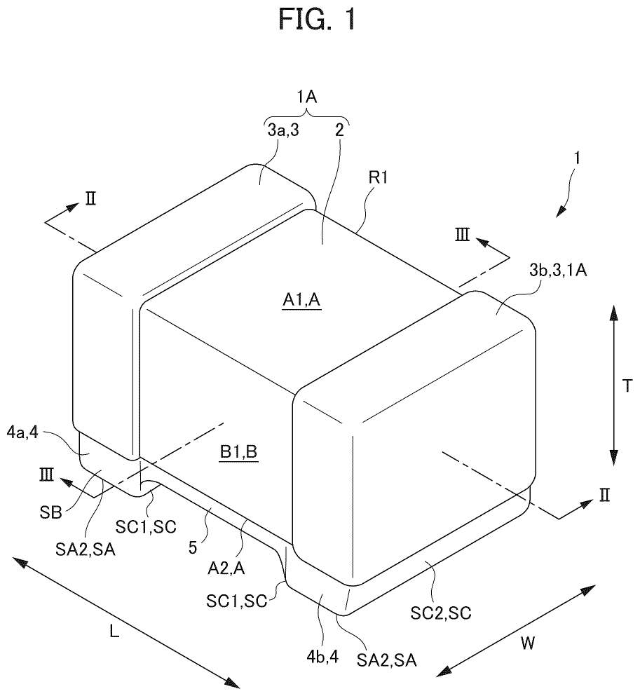

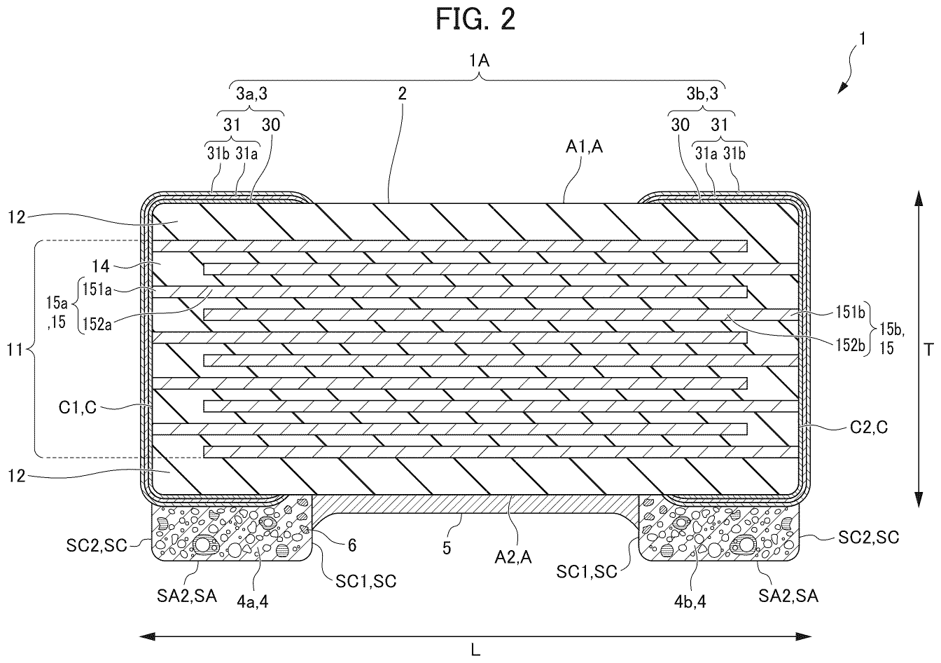

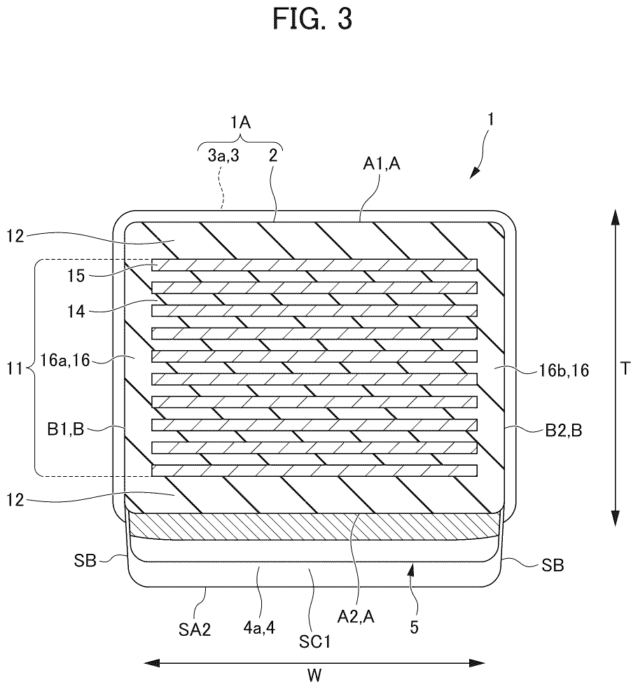

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to the present example embodiment. FIG. 3 is a cross-sectional view taken along the line III-III in FIG. 1 of the multilayer ceramic capacitor 1 according to the present example embodiment.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, spacers 4 attached to the capacitor main body 1A and including a protective material 6, and a reinforcement portion 5 provided between the two spacers 4. The multilayer body 2 includes an inner layer portion 11 including dielectric layers 14 and internal electrode layers 15 laminated together.

In the following description, as a term representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are stacked (or laminated) is defined as the lamination direction T. The direction intersecting both the length direction L and the lamination direction T is defined as the width direction W.

In addition, in example embodiments of the present invention, the width direction W is orthogonal or substantially orthogonal to both the length direction L and the lamination direction T.

### Outer Surfaces of the Multilayer Body 2

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably has rounded ridge portions R1 including corner portions. The ridge portions R1 are portions where two surfaces of the multilayer body 2 intersect, i.e., the main surface A and the lateral surface B, the main surface A and the end surface C, or the lateral surface B and the end surface C intersect.

### Multilayer Body 2

The multilayer body 2 includes an inner layer portion 11 that generates capacitance, outer layer portions 12 that sandwich the inner layer portion 11 from the lamination direction T, and side gap portions 16 that sandwich the inner layer portion 11 and the outer layer portions 12 from the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 are each made of a ceramic material. As the ceramic material, for example, a dielectric ceramic with BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1 and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of each of the first internal electrode layers 15a and the second counter portion 152b of each of the second internal electrode layers 15b.

The internal electrode layers 15 are preferably made of a metal material, for example, such as nickel (Ni), copper (Cu), silver (Ag), palladium (Pd), silver-palladium (Ag—Pd) alloy, gold (Au), etc.

### Outer Layer Portion 12

The outer layer portion 12 can be made of the same material as the dielectric layers 14 of the inner layer portion 11.

### Side Gap Portion 16

The side gap portions 16 sandwich the inner layer portion 11 and the outer layer portion 12 from the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portion 16 can be made of the same material as the dielectric layer 14.

### External Electrode 3

The external electrode 3 includes a first external electrode 3a provided on the first end surface C1, and a second external electrode 3b provided on the second end surface C2. The external electrode 3 covers not only the end surface C, but also a portion of the main surface A and a portion of the lateral surface B continuous with the end surface C.

As described above, the end portion of the first extension portion 151a of each of the first internal electrode layers 15a is exposed at the first end surface C1, and electrically connected to the first external electrode 3a. Furthermore, the end portion of the second extension portion 151b of each of the second internal electrode layers 15b is exposed at the second end surface C2, and is electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a plated layer 31. However, it is not necessarily required that the external electrodes 3 include such a layered configuration.

The base electrode layer 30 is formed, for example, by applying and firing an electrically conductive paste containing copper (Cu). The base electrode layer 30 may also include glass and ceramic material, for example. The configuration of the base electrode layer 30 is not limited thereto.

The plated layer 31 includes, for example, a nickel (Ni) plated layer 31a provided on the surface of the base electrode layer 30, and a tin (Sn) plated layer 31b provided on the surface of the nickel (Ni) plated layer 31a. The configuration of the plated layer 31 is not limited thereto.

### Spacer 4

The spacer 4 includes a pair of a first spacer 4a and a second spacer 4b. The first spacer 4a is provided on the second main surface A2, which is a substrate mounting surface of the capacitor main body 1A, and adjacent to the end surface C1 located on one side in the length direction L. The second spacer 4b is provided on the second main surface A2 and adjacent to the end surface C2 located on the other side in the length direction L. Each spacer 4 connects with a portion of the external electrode 3 provided on the second main surface A2. When the substrate mounting surface of the capacitor main body 1A is the first lateral surface B1, the first spacer 4a is provided on the first lateral surface B1, which is a substrate mounting surface of the capacitor main body 1A, and adjacent to the end surface C1 located on one side in the length direction L. The second spacer 4b is provided on the first lateral surface B1 and adjacent to the end surface C2 located on the other side in the length direction L.

In the following, in each spacer 4, the two surfaces that are opposed to each other in the lamination direction T are defined as spacer main surfaces SA, the two surfaces that are opposed to each other in the length direction L are defined as spacer end surfaces SC, and the two surfaces that are opposed to each other in the width direction W are defined as spacer lateral surfaces SB.

In addition, among the two spacer end surfaces SC, a spacer end surface SC adjacent to the middle portion in the length direction L of the capacitor main body 1A is defined as a middle-side spacer end surface SC1, and a spacer end surface SC on the outer side in the length direction L of the multilayer body 2 is defined as an outer side spacer end surface SC2.

Among the two spacer main surfaces SA, the spacer main surface SA adjacent to the capacitor main body 1A is defined as the main body-side spacer main surface SA1, and the spacer main surface SA on the other side is defined as the mounting-side spacer main surface SA2. When the substrate mounting surface of the capacitor main body 1A is the first lateral surface B1, among the two spacer lateral surfaces SB, the spacer lateral surface SB adjacent to the capacitor main body 1A is defined as the main body-side spacer lateral surface SB1, and the spacer lateral surface SB on the other side is defined as the mounting-side spacer main surface SB2.

In an example embodiment of the present invention, the length in the length direction L of each spacer 4 is longer than a corresponding one of the external electrodes 3 provided on the second main surface A2. That is, the middle-side spacer end surface SC1 of each spacer 4 is located beyond a corresponding one of the external electrodes 3 in the length direction L. This provides a portion where the main body-side spacer main surface SA1 of each of the spacers 4 is in direct contact with the second main surface A2 of the multilayer body 2. However, the present invention is not limited thereto, and the length in the length direction L of each spacer 4 may be shorter than a corresponding one of the external electrodes provided on the second main surface A2. The same also applies when the substrate mounting surface of the capacitor main body 1A is the first lateral surface B1.

In an example embodiment of the present invention, the external electrodes 3 each include the base electrode layer 30 and the plated layer 31 that covers the base electrode layer 30, and each spacer 4 is provided on the surface of the plated layer 31. However, for example, each spacer 4 may be provided on the surface of the base electrode layer 30, and a second plated layer may cover each spacer 4 and the base electrode layer 30. By providing the second plated layer, the bonding strength between each spacer 4 and the base electrode layer 30 is improved.

### Material of Spacer 4

Each spacer 4 includes, for example, either copper (Cu) or nickel (Ni) as metal powder and tin (Sn) as metal. The copper (Cu) and nickel (Ni) may be coated with silver (Ag), for example. In addition, each spacer 4 may further include, for example, silver (Ag) as a metal of an intermetallic compound.

The intermetallic compound formed by adding tin (Sn) to either copper (Cu) or nickel (Ni) has a melting point that does not melt even when soldering is performed when mounting the multilayer ceramic capacitor 1 on a wiring board, and no deformation due to heat occurs. Therefore, the shape of each spacer 4 can be reliably maintained, and it is possible to provide each spacer 4 while maintaining the desired configuration even during soldering. In particular, for example, an intermetallic compound formed by adding tin (Sn) to an alloy of copper (Cu) and nickel (Ni) is preferable as a component for forming each spacer 4.

The metal region MP formed by the metal powder may include a phenol resin, for example. The phenol resin coats the intermetallic compound particles and is scattered to fill the gaps between the particles. The phenol resin may not completely coat the intermetallic compound particles. In addition, by using a phenol resin, the amount of gas generated during the heat treatment when forming each spacer 4 can be reduced, thus reducing voids in each spacer 4. The phenol resin may be exposed on the surface of each spacer 4 and cover at least a portion of the surface of each spacer 4. By covering the surface of each spacer 4 with a phenol resin, the smoothness of the surface of each spacer 4 is improved, and the mechanical strength of each spacer 4 can be increased.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, polyoxystyrenes such as polyparaoxystyrene, and the like.

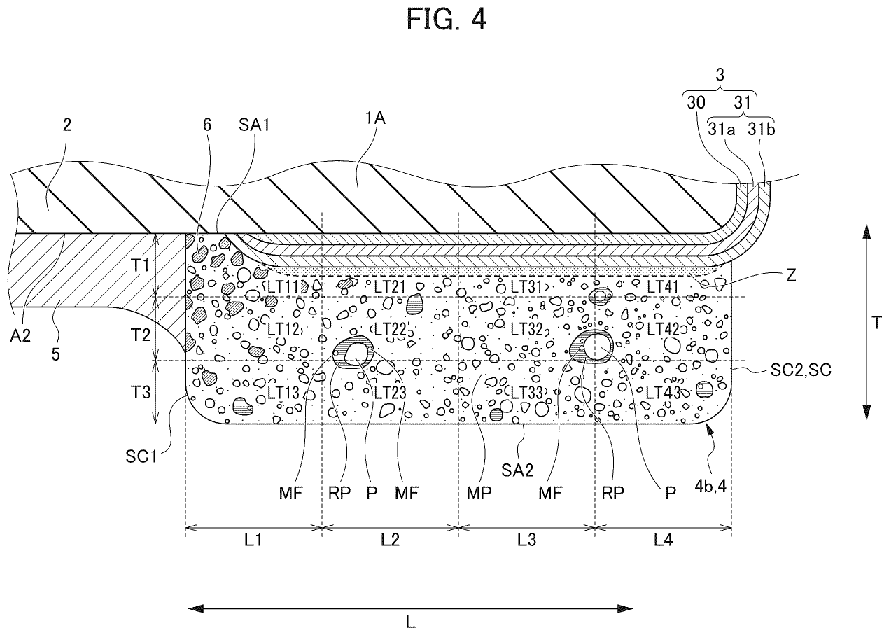

FIG. 4 is an enlarged view of a portion of one of the spacers 4 in the cross-sectional view of the multilayer ceramic capacitor 1 shown in FIG. 2. As shown in FIG. 4, the resin region RP including phenol resin may include metal powder MF, for example. The metal powder MF reduces or prevents the shrinkage of the phenol resin, and can relax the compressive stress due to the phenol resin.

The spacer 4 preferably has a void ratio of, for example, about 20% or less in the region Z within about 5 μm from the interface with a corresponding one of the external electrodes 3. By keeping the void ratio low, the bonding area of the spacer 4 that bonds with the external electrode 3 increases, thus improving the bonding strength with the external electrode 3.

Inside the spacer 4, voids P are provided, and the maximum diameter of the voids P is, for example, preferably about ½ or less of the maximum dimension in the thickness of the spacer 4 in the lamination direction T. If it exceeds about ½, cracks are likely to occur with the voids P as starting points, reducing the strength of the spacer 4. When the substrate mounting surface of the capacitor main body 1A is the first lateral surface B1, the maximum diameter of the voids P formed inside the spacer 4 is, for example, preferably about ½ or less of the maximum dimension in the thickness of the spacer 4 in the width direction W.

In the above, a configuration including metal intermetallic compounds and a phenol resin is shown as an example of the spacer material, but the present invention is not limited thereto, and may include different types of metal components, or may include resins other than the phenol resin such as an epoxy resin and rosin, and/or a glass component, for example.

Also, it may be formed without including resin. It may be manufactured with, for example, a material including copper or copper alloy, and provided to be connected via Ni plating and solder.

When the spacer 4 is smaller than the external electrode 3 in a plan view from the direction connecting the surface to which the spacer 4 is applied and the surface opposed to that surface, it is preferable to provide a direction identification marker to at least a portion of the spacer 4. The direction identification marker indicates the direction for opposing the second main surface A2 or the first lateral surface B1 where the spacer 4 is provided toward the wiring board when mounting the multilayer ceramic capacitor 1 on the wiring board, and can include, for example, a marker such as coloring the spacer 4 with a color different from the external electrode 3, printing a direction identification mark such as a QR code (registered trademark) to identify the direction, or providing a recessed portion in a portion of the multilayer body. As for coloring, the phenol resin included in the spacer 4 may be exposed on the surface of the spacer 4 to exhibit a color different from the external electrode 3. Even when the spacer 4 is larger than the external electrode 3, a direction identification marker may be provided.

For example, when the color tone of the spacer 4 and the external electrode 3 are the same as or similar to each other, it may not be possible to determine which side has the surface to which the spacer 4 is applied when viewed from above, potentially causing image processing errors. However, by providing a direction identification marker, such image processing errors can be prevented.

### Protective Material 6

In an example embodiment of the present invention, each spacer 4 further includes a protective material 6 inside. The protective material 6 preferably includes, for example, resin, water repellent agent, ceramics, glass, or the like. As the resin material, it may include, for example, an epoxy resin as a main component and may be combined with a phenol resin as a curing agent, and a curing accelerator added thereto. In this case, the curing agent may be, for example, an acid anhydride system, amine system, ester system, or the like.

Furthermore, the protective material 6 has higher bonding strength with, for example, the dielectric components included in the multilayer body 2 than the intermetallic compound included in each spacer 4. In this case, the adhesion between the multilayer body 2 and each spacer 4 can be made stronger by the bonding between the protective material 6 and the multilayer body 2.

### Content of Protective Material 6 in Length Direction L

As shown in FIG. 4, one of the spacers 4 is divided into four regions L1, L2, L3, and L4 along lines, each extending in the lamination direction T, from the middle-side spacer end surface SC1 toward the outer-side spacer end surface SC2 in the length direction L.

When considering two divided regions as L1+L2 and L3+L4, the content ratio of the protective material 6 is preferably higher in the region L1+L2 closer to the middle portion of the capacitor main body in the length direction L than in the region L3+L4 farther from the middle portion.

Furthermore, when considering four divided regions as L1, L2, L3, and L4, the content ratio of the protective material 6 is preferably highest in the region L1 closest to the middle portion of the capacitor main body in the length direction L, followed by the region L2 which is the second closest to the middle portion, and it is more preferable that the content ratio of the protective material 6 decreases in order from the region L1 closest to the middle portion, to L2, L3, and L4.

### Content of Protective Material 6 in Lamination Direction T

The spacer 4 is divided into the three regions T1, T2, and T3 along lines each extending in the length direction L. T1 is closest to the capacitor main body 1A. In other words, T1, T2, and T3 are provided in this order from the main body-side spacer main surface SA1 toward the mounting-side spacer main surface SA2 in the lamination direction T.

At this time, it is preferable that the content ratio of the protective material 6 is higher in the region T1 closest to the capacitor main body 1A than in the region T3 farthest from the capacitor main body 1A. It is preferable that the content ratio of the metal component in each spacer 4 is highest in the region T3. When the content ratio of the metal component is high in the region T3 that bonds with solder, a strong bond between the solder and each spacer 4 is ensured.

### Content of Protective Material 6 in Length Direction L and Lamination Direction T

Each spacer 4 is divided into the four regions L1, L2, L3, and L4 in the length direction L from the middle-side spacer end surface SC1 toward the outer-side spacer end surface SC2. Further, each spacer 4 is divided into the three regions T1, T2, and T3 in the lamination direction T. T1 is closest to the capacitor main body 1A in the lamination direction T. T1, T2, and T3 are provided in this order from the main body-side spacer main surface SA1 toward the mounting-side spacer main surface SA2. Therefore, each spacer 4 includes a total of 12 divided regions.

At this time, it is preferable that the content ratio of the protective material 6 is highest in the region LT11, which corresponds to the region L1 closest to the middle-side spacer end surface SC1 and the region T1 closest to the capacitor main body 1A. Further, it is preferable that the content ratio of the protective material 6 decreases as approaching the outer-side spacer end surface SC2 and the mounting-side spacer main surface SA2, and the content ratio of the protective material 6 is lowest in the region LT43, which corresponds to L4 and T3.

As described above, in an example embodiment of the present invention, each spacer 4 is longer than the length in the length direction L of a corresponding one of the external electrodes 3 provided on the second main surface A2. That is, the main body-side spacer main surface SA1 of each spacer 4 is in direct contact with the second main surface A2 of the multilayer body 2 that is not covered by a corresponding one of the external electrodes 3. The portion in direct contact therewith corresponds to the region LT11 with the highest content ratio of the protective material 6. Therefore, each spacer 4 is firmly bonded to the multilayer body 2 by the bond between the protective material 6 and the dielectric components of the multilayer body 2.

In each spacer 4, since the content ratio of the protective material 6 decreases as it approaches the outer-side spacer end surface SC2, the intermetallic compound and metal component relatively increase. Further, each spacer 4 is in contact with a corresponding one of the external electrodes 3 at a portion adjacent to the outer-side spacer end surface SC2 such that it is possible for each spacer 4 to include a larger contact area between a corresponding one of the external electrodes 3, and the intermetallic compound and metal component. This ensures favorable electrical conduction between the spacers 4 and the external electrodes 3 and increases the bonding strength.

Furthermore, since the content ratio of the protective material 6 in each spacer 4 decreases and the metal component increases as it approaches the mounting-side spacer main surface SA2, a strong bond between the solder and each spacer 4 is ensured.

### Reinforcement Portion 5

As shown in FIG. 1, the reinforcement portion 5 is provided between the two spacers 4 to cover the second main surface side of the capacitor main body 1A. At this time, the length in the length direction of each of the external electrodes provided on the main surface and the length in the length direction of each of the spacers may be the same or approximately the same, or the length in the length direction of each of the external electrodes may be longer than the length in the length direction of each of the spacers.

### Material of Reinforcement Portion 5

It is preferable that the main component of the reinforcement portion 5 is the same as the main component of the protective material 6. By having the same main component, the protective material 6 of each spacer 4 and the reinforcement portion 5 bond together, thus improving the bonding strength between each spacer 4 and the protective material 6.

### Shape of Reinforcement Portion 5

As shown in FIG. 2, the reinforcement portion 5 is continuously provided in the length direction L between the middle-side spacer end surface SC1 of one spacer 4 and the middle-side spacer end surface SC1 of the other spacer 4, and covers the second main surface A2 of the capacitor main body 1A (multilayer body 2) and each of the middle-side spacer end surfaces SC1 of the two spacers 4. Therefore, it is possible to protect the capacitor main body 1A more firmly. When the substrate mounting surface of the capacitor main body 1A is the first lateral surface B1, it covers the first lateral surface B1 of the capacitor main body 1A (multilayer body 2) and each of the middle-side spacer end surfaces SC1 of the two spacers 4.

However, the reinforcement portion 5 does not necessarily need to be continuous between the first spacer 4a and the second spacer 4b. The reinforcement portion 5 may be provided discontinuously by dividing it into one portion covering the middle-side spacer end surface SC1 of the first spacer 4a and a portion of the second main surface A2 of the capacitor main body 1A (multilayer body 2), and another portion covering the middle-side spacer end surface SC1 of the second spacer 4b and a portion of the second main surface A2 of the capacitor main body 1A (multilayer body 2). In a case where the substrate mounting surface of the capacitor main body 1A is the first lateral surface B1, the reinforcement portion 5 may be provided discontinuously by dividing it into one portion covering the middle-side spacer end surface SC1 of the first spacer 4a and a portion of the first lateral surface B1 of the capacitor main body 1A (multilayer body 2), and another portion covering the middle-side spacer end surface SC1 of the second spacer 4b and a portion of the first lateral surface B1 of the capacitor main body 1A (multilayer body 2).

### Measurement Method

The content ratio of the protective material 6 can be measured as follows, for example. First, one spacer 4 is polished until the dimension in the width direction W of the spacer 4 becomes about ½ so that the cross-section of the spacer lateral surface SB is visible.

The cross section of the spacer 4 is photographed using a microscope (Axio (registered trademark)-Imager-MAT, manufactured by ZEISS) at a total magnification of about 100 times to about 500 times.

In the captured image, the spacer 4 is divided into three regions in the lamination direction T along lines extending in the length direction L, and also divided into two or four regions in the length direction L along lines extending in the lamination direction T, at the region where the thickness in the lamination direction T of the spacer 4 is the thickest.

### Method of Manufacturing Multilayer Ceramic Capacitor 1

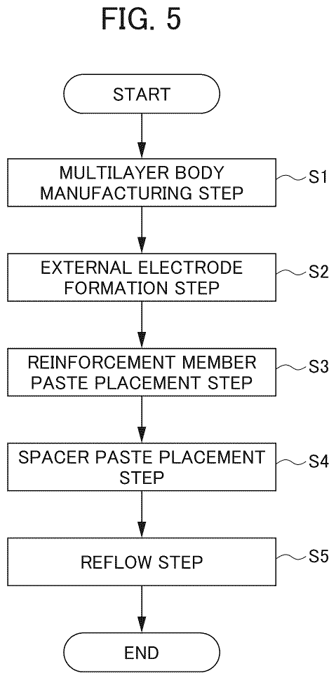

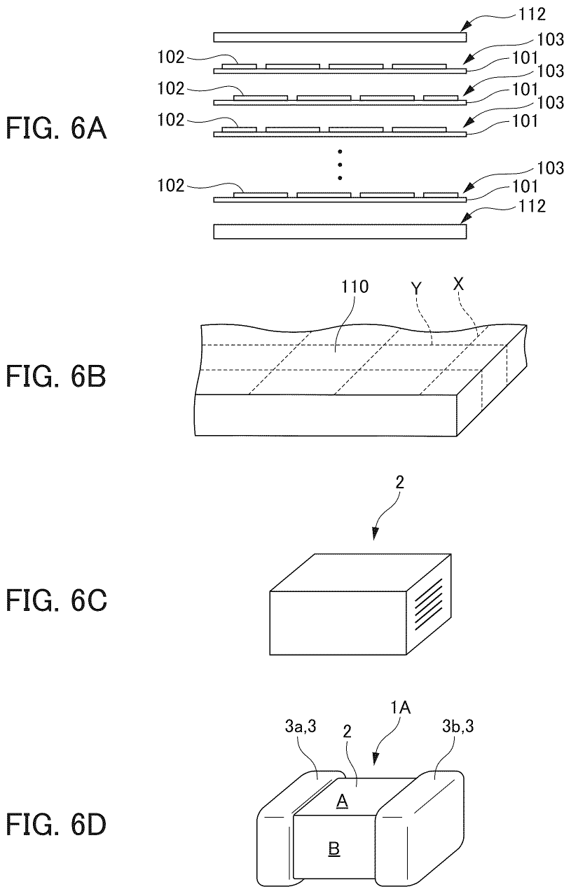

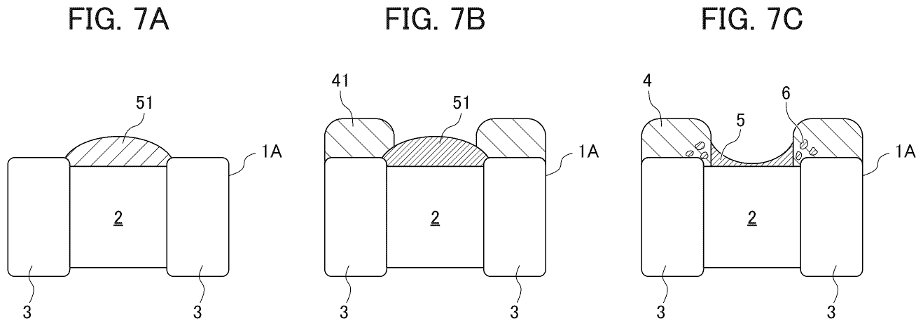

FIG. 5 is a flowchart explaining an example of a method of manufacturing the multilayer ceramic capacitor 1 according to an example embodiment of the present invention. The method of manufacturing the multilayer ceramic capacitor 1 includes a multilayer body manufacturing step S1, an external electrode formation step S2, a protective material and reinforcement portion paste placement step S3, a spacer paste placement step S4, and a reflow step S5. FIGS. 6A to 6D are diagrams explaining the multilayer body manufacturing step S1 and the external electrode formation step S2. FIGS. 7A to 7C are diagrams explaining the protective material and reinforcement portion paste placement step S3, the spacer paste placement step S4, and the reflow step S5.

### Multilayer Body Manufacturing Step S1

A ceramic slurry including ceramic powder, binder, and solvent is formed into a sheet on the surface of a carrier film using, for example, a die coater, gravure coater, micro gravure coater, etc., to create a multilayer ceramic green sheet 101 that defines and functions as the dielectric layer 14. Next, a material sheet 103 is created by printing an electrically conductive paste in a strip pattern on the multilayer ceramic green sheet 101 by, for example, screen printing, inkjet printing, gravure printing, etc., or printing an electrically conductive pattern 102 that defines and functions as the internal electrode layer 15 on the surface of the multilayer ceramic green sheet 101.

Next, as shown in FIG. 6A, a plurality of material sheets 103 are stacked such that the electrically conductive patterns 102 face in the same direction and the electrically conductive patterns 102 are offset from each other by, for example, about half a pitch in the length direction L between adjacent material sheets 103. Furthermore, ceramic green sheets 112 for outer layer portions, which define and function as the outer layer portions 12, are stacked on both sides of the plurality of stacked material sheets 103.

The plurality of stacked material sheets 103 and the ceramic green sheets 112 for outer layer portions are pressed together using, for example, a hydrostatic press or the like to create a mother block 110 as shown in FIG. 6B.

Next, the mother block 110 is cut along cutting lines X and cutting lines Y that intersect the cutting lines X as shown in FIG. 6B to manufacture a plurality of multilayer bodies 2 as shown in FIG. 6C.

### External Electrode Formation Step S2

Next, a base electrode layer 30 is formed by applying and firing an electrically conductive paste including, for example, copper (Cu) to the end surfaces C of the multilayer body 2. The base electrode layer 30 extends not only on both end surfaces C of the multilayer body 2, but also to the main surfaces A and lateral surfaces B, so as to cover a portion of the main surfaces A adjacent to the end surfaces C. Then, a plated layer 31 is formed on the surface of the base electrode layer 30, including, for example, a nickel (Ni) plated layer 31a and a tin (Sn) plated layer 31b provided on the surface of the nickel (Ni) plated layer 31a, to manufacture a capacitor main body 1A as shown in FIG. 6D. The configuration of the external electrode is not limited thereto.

### Reinforcement Portion Paste Placement Step S3

In an example embodiment of the present invention, the protective material 6 and the reinforcement portion are made of the same material. In this case, first, the surface of the capacitor main body 1A on which a spacer 4 is provided is cleaned with a solvent, and as shown in FIG. 7A, a reinforcement portion paste 51 is applied between the two external electrodes 3.

### Spacer Paste Placement Step S4

Next, as shown in FIG. 7B, a spacer paste 41 is applied on the external electrodes 3 of the capacitor main body 1A in a state where the reinforcement portion paste 51 is applied between the two external electrodes 3. At this time, the spacer paste 41 is applied to cover not only the external electrodes 3, but also a portion of the reinforcement portion paste 51.

### Reflow Step S5

Next, as shown in FIG. 7C, the uncured reinforcement portion paste 51 and the uncured spacer paste 41 are simultaneously cured by reflow. At this time, the reinforcement portion enters the region of the spacer paste 41 adjacent to the reinforcement portion paste 51 as the protective material 6. This makes it possible to form a region with a high content of the protective material 6. In addition, by increasing the amount of the reinforcement portion paste 51 at this time, it is possible to increase the content of the protective material 6 in the spacer 4.

### Modified Example

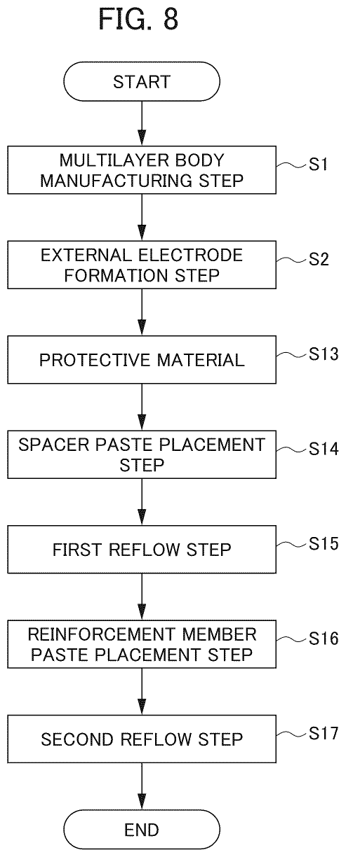

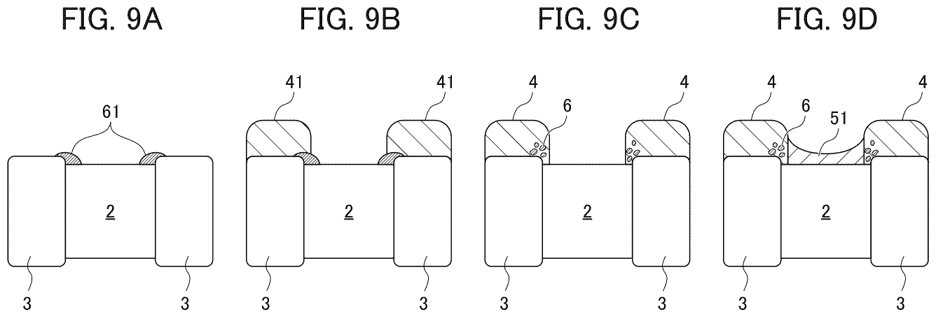

In a case of a modified example of an example embodiment of the present invention in which the protective material 6 and the reinforcement portion 5 are made of different materials, the following steps are performed in order as shown in FIGS. 8, 9A, 9B, and 9C, after the external electrode formation step S2. FIG. 8 is a flowchart showing the protective material 6 and reinforcement portion formation step in the modified example, and FIGS. 9A to 9D are diagrams explaining the protective material 6 and reinforcement portion formation step in the modified example.

### Protective Material Paste Placement Step S13

As shown in FIG. 9A, a protective material paste 61 which defines and functions as the material of the protective material 6 is applied by, for example, a dispenser or squeegee printing to the portion where the multilayer body 2 is exposed between the external electrodes 3 of the capacitor main body 1A. The protective material paste 61 is applied so as to be in contact with the external electrodes 3 and not to cover, for example, about 15% or more of the area of the external electrodes 3.

### Spacer Paste Placement Step S14

As shown in FIG. 9B, a spacer paste 41 is applied on the capacitor main body 1A on which the protective material paste 61 has been applied.

### First Reflow Step S15

As shown in FIG. 9C, reflow is performed with the protective material paste 61 and the spacer paste 41 applied to the capacitor main body 1A. By simultaneously curing the uncured protective material paste 61 and spacer paste 41 by reflow, spacers 4 can be formed in which the content ratio of the protective material 6 differ depending on locations. In addition, by changing the amount and position of application of the protective material 6, it is possible to control the content ratio of the protective material 6 in each spacer 4.

### Reinforcement Portion Paste Placement Step S16

As shown in FIG. 9D, the surface of the capacitor main body 1A on which each spacer 4 is provided is cleaned with a solvent, and a reinforcement portion paste 51 is provided between the two spacers 4 on the capacitor main body 1A on which each spacer 4 is provided, using a dispenser or squeegee printing, for example.

### Second Reflow Step S17

Next, reflow is performed on the capacitor main body 1A on which the reinforcement portion paste 51 is provided between the two spacers 4. The uncured reinforcement portion paste 51 is cured by reflow. The multilayer ceramic capacitor 1 of the present example embodiment is manufactured through the above steps.

According to the multilayer ceramic capacitor 1 of the present example embodiment, since the spacers 4 are attached to the capacitor main body 1A, it is possible to buffer the vibration generated in the capacitor main body 1A by the spacers 4, and it is possible to reduce or prevent the vibration transmitted to the mounting substrate.

Further, according to the multilayer ceramic capacitor 1 of the present example embodiment, since the reinforcement portion 5 is attached between the spacers 4, it is possible to strengthen the bonding strength between the external electrode 3 and the spacers 4, and it is possible to reduce or prevent the spacers 4 from peeling off from the capacitor main body 1A.

Each spacer 4 is longer in the length direction L than the portion of each of the external electrodes 3 covering the second main surface A2 of the capacitor main body 1A.

Further, each spacer 4 includes an intermetallic compound including, for example, at least one of Cu or Ni as a high melting point metal and Sn as a low melting point metal, and a protective material.

In addition, the protective material 6 has higher bonding strength with components included in the multilayer body 2, such as dielectric components, than the intermetallic compound included in each spacer 4.

Furthermore, when each spacer 4 is divided into two regions in the length direction L, the region closer to the middle portion in the length direction L of the capacitor main body 1A has a higher content ratio of the protective material 6 than the region farther from the middle portion in the length direction of the capacitor main body 1A.

In this way, the joining portion between each spacer 4 and the multilayer body 2 has a high content ratio of the protective material 6. Since the bonding strength between the protective material 6 and the dielectric components of the multilayer body 2 is strong, it is possible to ensure a strong bond between each spacer 4 and the multilayer body 2.

Further, the joining portion between each spacer 4 and a corresponding one of the external electrodes 3 has a low content ratio of the protective material and contains more intermetallic compound. Therefore, it is possible to ensure a strong bond between each spacer 4 and a corresponding one of the external electrodes 3 by the metal bonding between the intermetallic compound of each spacer 4 and a corresponding one of the external electrodes 3.

Although example embodiments of the present invention have been described above, the present invention is not limited to the example embodiments, and can be provided various configurations without departing from the gist of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor main body including a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction; and
two external electrodes each on a corresponding one of the two end surfaces, and each extending to the two main surfaces and the two lateral surfaces to cover a portion of each of the two main surfaces and a portion of each of the two lateral surfaces; and
two spacers on one of the two main surfaces of the capacitor main body, the two spacers being respectively adjacent to one of the two end surfaces and adjacent to an other of the two end surfaces with a corresponding one of the two external electrodes respectively covering the portion of each of the two main surfaces interposed between the capacitor main body and a corresponding one of the two spacers; wherein
each of the two spacers is longer in the length direction than a corresponding one of the external electrodes covering the portion of each of the two main surfaces, and includes a metal component and a protective material; and
when each of the two spacers is divided into two regions in the length direction along a line extending in the lamination direction, a region closer to a middle portion in the length direction of the capacitor main body has a higher content ratio of the protective material than a region farther from the middle portion.

2. The multilayer ceramic electronic component according to claim 1, wherein the protective material includes a resin.

3. The multilayer ceramic electronic component according to claim 1, wherein, when each of the spacers is divided into three regions in the lamination direction, a region closest to the capacitor main body has a higher content ratio of the protective material than a region farthest from the capacitor main body.

4. The multilayer ceramic electronic component according to claim 3, wherein, among the three regions divided in each of the two spacers, a content ratio of the protective material decreases in order from the region closer to the capacitor main body toward the region farther from the capacitor main body.

5. The multilayer ceramic electronic component according to claim 1, wherein, when each of the spacers is divided into four regions in the length direction, a region closest to the middle portion in the length direction of the capacitor main body has a highest content ratio of the protective material, and a region second closest to the middle portion in the length direction of the capacitor main body has a second highest content ratio of the protective material.

6. The multilayer ceramic electronic component according to claim 1, wherein
a reinforcement portion is provided between the two external electrodes; and
a main component of the reinforcement portion is the same as a main component of the protective material.

7. The multilayer ceramic electronic component according to claim 6, wherein the reinforcement portion is continuously provided in the length direction.

8. The multilayer ceramic electronic component according to claim 2, wherein the resin of the protective material includes an epoxy resin.

9. The multilayer ceramic electronic component according to claim 2, wherein the protective material further includes at least one of a water repellent agent, ceramic, or glass.

10. The multilayer ceramic electronic component according to claim 1, wherein each of the two spacers includes copper or nickel and tin.

11. A multilayer ceramic electronic component comprising:
a capacitor main body including a multilayer body including two main surfaces opposed to each other in a lamination direction, two end surfaces opposed to each other in a length direction intersecting the lamination direction, and two lateral surfaces opposed to each other in a width direction intersecting the lamination direction and the length direction; and
two external electrodes each on a corresponding one of the two end surfaces, and each extending to the two main surfaces and the two lateral surfaces to cover a portion of each of the two main surfaces and a portion of each of the two lateral surfaces; and
two spacers on one of the two main surfaces of the capacitor main body, the two spacers being respectively adjacent to one of the two end surfaces and adjacent to an other of the two end surfaces with a corresponding one of the two external electrodes respectively covering the portion of each of the two main surfaces interposed between the capacitor main body and a corresponding one of the two spacers; wherein
each of the spacers includes a metal component and a protective material;
when each of the two spacers is divided into two regions in the length direction along a line extending in the lamination direction, a region closer to a middle portion in the length direction of the capacitor main body has a higher content ratio of the protective material than a region farther from the middle portion; and
a reinforcement portion is provided between the two external electrodes.

12. The multilayer ceramic electronic component according to claim 11, wherein the protective material includes a resin.

13. The multilayer ceramic electronic component according to claim 11, wherein, when each of the spacers is divided into three regions in the lamination direction, a region closest to the capacitor main body has a higher content ratio of the protective material than a region farthest from the capacitor main body.

14. The multilayer ceramic electronic component according to claim 13, wherein, among the three regions divided in each of the two spacers, a content ratio of the protective material decreases in order from the region closer to the capacitor main body toward the region farther from the capacitor main body.

15. The multilayer ceramic electronic component according to claim 11, wherein, when each of the spacers is divided into four regions in the length direction, a region closest to the middle portion in the length direction of the capacitor main body has a highest content ratio of the protective material, and a region second closest to the middle portion in the length direction of the capacitor main body has a second highest content ratio of the protective material.

16. The multilayer ceramic electronic component according to claim 11, wherein
a reinforcement portion is provided between the two external electrodes; and
a main component of the reinforcement portion is the same as a main component of the protective material.

17. The multilayer ceramic electronic component according to claim 16, wherein the reinforcement portion is continuously provided in the length direction.

18. The multilayer ceramic electronic component according to claim 12, wherein the resin of the protective material includes an epoxy resin.

19. The multilayer ceramic electronic component according to claim 12, wherein the protective material further includes at least one of a water repellent agent, ceramic, or glass.

20. The multilayer ceramic electronic component according to claim 11, wherein each of the two spacers includes copper or nickel and tin.
